(19) United States
(12) Patent Application Publication
(10) Pub. No.: US 2026/0029319 A1
(43) Pub. Date: Jan. 29, 2026

(54) ANALYTICAL DEVICE FOR SOLVENT CHARACTERIZATION

(71) Applicant: Agilent Technologies, Inc., Santa Clara, CA (US)

(72) Inventors: Konstantin Shoykhet, Karlsruhe (DE); Clemens Plachetka, Malsch (DE); Robert Pawlus, Waldbronn (DE)

(21) Appl. No.: 19/150,020

(22) PCT Filed: Jan. 26, 2024
(86) PCT No.: PCT/IB2024/050733

§ 371 Date: Jul. 22, 2025

(30) Foreign Application Priority Data
Jan. 30, 2023 (GB) 2301281.8

(51) Int. Cl. G01N 11/00

(52) U.S. Cl. CPC G01N 11/00; G01N 2011/002; G01N 2011/0093

(57) ABSTRACT

An analytical device includes a fluid compartment configured to accommodate a solvent, a blocking device configured to close an input and/or an output of the fluid compartment, a flow sensor and/or a pressure sensor coupled to the fluid compartment and configured to perform a measurement with respect to the solvent, a temperature change device coupled to the fluid channel and configured to perform a temperature change with respect to the fluid compartment, and a determination device, configured to determine a thermal property of the solvent based on the measurement and the temperature change.

### CROSS-REFERENCE TO RELATED APPLICATIONS

This application is the national stage under 35 U.S.C. 371 of International Application No. PCT/IB2024/050733, filed on Jan. 26, 2024; which claims priority to UK Patent Application No. GB 2301281.8, filed on Jan. 30, 2023; the entire contents of each of which are incorporated by reference herein.

### TECHNICAL FIELD

The present disclosure relates to an analytical device for determining a thermal property of a solvent. The present disclosure further relates to a sample separation device, in particular a chromatography device such as a high-performance liquid chromatography (HPLC) device, that comprises the analytical device. The present disclosure further relates to a corresponding method and a corresponding use.

### BACKGROUND

Analytical devices are provided for analyzing a sample, such as for carrying out a chromatographic separation of the sample.

For example, for liquid separation in a chromatography system, a mobile phase comprising a sample fluid (e.g. a chemical or biological mixture) with compounds to be separated is driven through a stationary phase (such as a chromatographic column packing), thus separating different compounds of the sample fluid which may then be identified. The term compound, as used herein, shall cover compounds which might comprise one or more different components.

The mobile phase, typically comprised of one or more solvents, is pumped under high-pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high-pressure drop is generated across the column.

The mobile phase with the separated compounds exits the column and passes through a detector, which registers and/or identifies the molecules, for example by spectrophotometric absorbance measurements. A two-dimensional plot of the detector measurements against elution time or volume, known as a chromatogram, may be made, and from the chromatogram the compounds may be identified. For each compound, the chromatogram displays a separate curve feature also designated as a “peak”.

In preparative chromatography systems, a liquid as the mobile phase is provided usually at a controlled flow rate (e. g. in the range of 1 mL/min to thousands of mL/min, e.g. in analytical scale preparative LC in the range of 1-5 mL/min and preparative scale in the range of 4-200 mL/min) and at pressure in the range of tens to hundreds bar, e.g. 20-600 bar.

In high-performance liquid chromatography (HPLC), a liquid as the mobile phase has to be provided usually at a very controlled flow rate (e.g. in the range of microliters to milliliters per minute) and at high-pressure (typically 20-100 MPa, 200-1000 bar, and beyond up to currently 200 MPa, 2000 bar) at which compressibility of the liquid becomes noticeable.

In analytical devices, specifically in liquid chromatography (in particular HPLC), it may be important to provide an accurate solvent flow, even in the case that specific properties of the solvent are not known or are not downloaded to the control unit of an analytical device.

The common definition of solvent flow might relate to a kind of “reference” conditions, which may include atmospheric pressure and a reference temperature (e.g. 25° C.). It may thus be important that a relation of the solvent volume displaced by a solvent (mobile phase) drive (in particular a pump) and the solvent volume under reference conditions can be established.

Specifically, the volume or density change caused by compression through the solvent drive may be accounted for (solvent compressibility), but also the volume or density deviation between the actual operation conditions and the reference conditions may be accounted for.

On the one hand, it is technically possible to evaluate the solvent compressibility and thus the relation between the compressed volume (e.g. the pump piston displacement) and the decompressed volume (i.e. the volume at the reference pressure) by observation/evaluation of the pump piston displacement in a routine operation. Thus, the pump piston displacement can be adjusted such that the solvent flow rate under a reference pressure is accurate.

On the other hand, however, the compensation of the temperature deviation still appears challenging. Because different solvents have different thermal expansion, metering and subsequently mixing them at different temperatures under unchanged volume ratio will result in different compositions, which will have a practically relevant effect on sample analysis, in particular chromatographic separation.

However, there are no directly observable process parameters in a pump cycle that clearly correlate with the thermal expansion properties of a solvent. In other words, without knowledge of the thermal properties of a solvent, it may not be possible to deliver an accurate solvent flow (under changing ambient temperature).

Accordingly, adjustment of device properties with respect to thermal properties of the solvent (e.g. correction of the pump piston displacement (during the pump operation)) may still be considered a challenge.

There may be a need to characterize a thermal property of a solvent in an analytical device (in particular regarding chromatography) in an efficient and reliable manner.

### SUMMARY

According to a first aspect, there is described an analytical device (in particular a sample separation device or a part thereof), comprising:
i) a fluid compartment (e.g. a fluid channel), configured to accommodate a solvent (so that a solvent can stream through the fluid compartment from an input to an output);
ii) a blocking device (e.g. a valve), configured to close the fluid compartment (in particular at an input side (upstream of the input) and/or an output side (downstream of the output);
iii) a flow sensor and/or a pressure sensor, coupled to the fluid compartment, and configured to perform a measurement (e.g. a flow rate or a pressure) with respect to the solvent;
iv) a temperature change device (e.g. a heating device or a pump), coupled to the fluid compartment, and configured to perform a temperature change with respect to the fluid compartment or a part thereof and/or the solvent or a part thereof; and
v) a determination device (e.g. a processor), configured to determine a (at least one) thermal property of the solvent based on the measurement and the temperature change.
   Optionally, depending on the intended use, the analytical device may comprise: a temperature measurement device (e.g. a temperature sensor), in particular configured to determine the actual temperature of the solvent or the part thereof, of a pump or of a part thereof such as a pump drive or a metering unit or of the environment or to determine the deviation of the actual temperature of (one of) the parts from the reference temperature.

According to a second aspect, a sample separation device (in particular a (fluidic) chromatography device, more in particular a high-performance liquid chromatography (HPLC) device) is described, wherein the sample separation device comprises an analytical device as described above.

According to a third aspect, there is described a method, comprising:
i) streaming a solvent in (to) a fluid compartment;
ii) blocking the fluid compartment (at an input side and/or an output side);
iii) performing a flow- and/or a pressure-related measurement with respect to the solvent;
iv) performing a temperature change with respect to the fluid compartment and/or the solvent therein (steps iii) and iv) can be simultaneous); and
v) determining a thermal property of the solvent based on the measurement and the temperature change.

According to a fourth aspect, there is described a use (method of using) of a (inline) measurement of the thermal expansion coefficient (or a related parameter) of a solvent to thereby adjust the solvent flow in a sample separation device (accurately), (to adjust a flow rate), in particular the average flow rate of a solvent, more in particular to adjust a partial flow rate of at least one of the components of the mobile phase.

In the context of the present document, the term “determination device” may in particular refer to an entity (e.g. a computer, a workstation, a processor, etc.) that is suitable to determine at least one thermal property based on i) a measurement of a flow rate and/or a pressure) and ii) a temperature change. For example, a temperature change by heating may cause a thermal expansion of the solvent in the fluid compartment, and the thermal expansion can be measured using the flow sensor, thereby determining the thermal expansion coefficient. The determination device may be further coupled to an adjustment device that applies the determined thermal property to adjust a property (parameter, operation parameter) of the analytic/separation device, for example a pump piston or plunger movement or a flow rate. There may be many options of how the determination device could be implemented. In one example, the determination device may be part of the sensor and/or the temperature change device. In another example, the determination device may be one or more stand-alone devices, and/or may (at least partially) operate remotely. In a further example, the determination device may be configured as part of a control device of the analytical device or the sample separation device. In another example, the determination device operates in/on-line or off-line.

In the context of the present document, the term “fluid compartment” may in particular refer to any volume suitable to accommodate/transport a fluid such as a liquid solvent. The fluid compartment may comprise a defined input side, where the fluid preferably streams into the fluid compartment, and a defined output side, where the fluid preferably streams out of the fluid compartment. In a preferred example, the fluid compartment is configured as a fluid channel or fluid capillary. In an example, the fluid compartment is directly located in the flow line of a chromatographic device, for example at a fluid channel between a solvent reservoir and a solvent pump. Thereby, an inline determination of the thermal property of the solvent may be enabled. The blocking device may hereby be realized or represented by a valve within the flow channel. In another example, the fluid compartment may be arranged separate of the “main” solvent flow, thereby enabling an off-line determination of the thermal property.

The term “temperature change device” may in particular refer to a device suitable to change the temperature (of a solvent) in a fluid compartment or in a part thereof. A temperature change may be caused in different manners, e.g. by heating or cooling. However, also the displacement of a pump piston can change the temperature of the solvent in the fluid compartment. In an example, the temperature change device can be arranged internal to the fluid compartment (e.g. a heating wire), while in another example, the temperature change device can be arranged external to the fluid compartment (e.g. a heating block or an induction coil). In these examples, the temperature change device is configured as a separate device. Yet, in another example, the temperature change device can be configured as part of the fluid compartment, e.g. as a metal layer at the fluid compartment sidewalls, that can be heated using an electric current, or can be represented by metal fluid compartment sidewalls themselves, which can be flown by an (preferably alternating) electric current. In a further example, the temperature change device may be realized as a cooling unit, internal or external to the fluid compartment.

In the context of the present document, the term “analytical device” may in particular refer to a device suitable to perform an analysis of a sample. In an example, the analytical device is applied to analyze (characterize) at least one thermal property of the solvent. The analytical device may comprise further analytical functionality, e.g. an analysis by sample separation (such as chromatography), which may be termed analysis domain in the following. In an example, the analytical device is integrated into a sample separation device (inline or offline) as a separate device or is manufactured together with the sample separation device. In other words, the analytical device may be a separate entity or part of a sample separation device entity (in particular a chromatographic device such as a HPLC). In the same manner, the analytical device may comprise its own control device (and determination/adjustment device) or may be (at least partially) controlled by the sample separation device control device (in this case, the determination/adjustment device may also be implemented at least partially in the sample separation device control device).

In the context of the present document, the term “chromatography device” may in particular refer to an instrument suitable to perform a chromatographic analysis, preferably for analyzing a sample, such as for carrying out a chromatographic separation of the sample. Examples of a chromatography device may include a high-performance liquid chromatography (HPLC) instrument or a gas chromatography (GC) instrument.

According to an exemplary embodiment, the disclosure may be based on the idea that a thermal property of a solvent in an analytical device (in particular regarding chromatography) can be determined in an efficient and reliable manner based on i) a flow/pressure measurement, and ii) a temperature change, with respect to the solvent within a fluid compartment, equipped with a fluid transport control means at at least one of its in-/outlets. The term “fluid transport control means” is understood as a device to monitor or to control, i.e. to allow or disallow a fluid flow and may comprise a blocking device (such as a fluidic valve, e.g. a rotary valve), a flow sensor, a pressure sensor, a piston or other appliance capable of modulating or changing the volume of the fluid compartment.

Specifically, the change, e.g. an increase of the temperature in the fluid compartment, for example caused by a heating device or a piston action, triggers an expansion of the solvent, wherein the expansion depends on the thermal property. Thus, by measuring the expansion using a flow senor or a pressure sensor, the thermal property may be determined in an efficient, fast, yet reliable manner.

Conventionally, the thermal properties of a solvent, specifically their in-line, run-time, real-time or start-up-phase determination have not been considered in an analytical device with respect to dosing or metering of a solvent. It has now been found by the inventors that a surprisingly efficient and reliable characterization of the thermal properties is possible directly in the analytical device. For example, the thermal expansion coefficient of the solvent may be determined in a HPLC solvent path inline or offline (e.g. in a special calibration cycle preceding the analytical domain/operation) according to one of the embodiments described in detail below.

Once the thermal property, such as the thermal expansion coefficient, of a solvent is determined, it can be used for the adjustment of the solvent flow, for example the solvent drive (piston motion) in the solvent displacement and solvent intake phases. By improving the accuracy of the solvent flow based on the thermal property, the accuracy of the whole sample analysis may be increased.

### EXEMPLARY EMBODIMENTS

In the following, further embodiments of the disclosure are described. These apply to the device(s) as well as to the method and the use.

In one embodiment, the thermal property of the solvent comprises at least one of density, volume, in particular specific volume, viscosity, compressibility. As will be described in the following regarding specific examples, many thermal parameters can be determined/estimated reliably using the described analytical device. Accordingly, the device can be used in a straightforward manner for many different applications.

In one embodiment, the thermal property comprises the thermal expansion coefficient, CTE, of the solvent. This may provide the advantage that an important thermal property can be determined/estimated in a straightforward and reliable manner in real-time or close to real time with the very same solvent, which is being used by the sample separation device, thus eliminating risk of a human error or confusion. Thermal expansion may be seen as the tendency of matter to change at least one of shape, area, volume, and density in response to a change in temperature. The thermal expansion coefficient or coefficient of thermal expansion (CTE) may be used as a measure for the thermal expansion of a matter such as a solvent. Regarding fluids, in particular the volumetric thermal expansion coefficient α (α_{V}) may be applied, which may be defined by the following formula (generally the pressure is kept constant here):

$$α = 1 / V ( dV / dT )$$

In one embodiment, the fluid compartment comprises at least one of a fluid channel, a fluid conduit, a fluid capillary, a hydraulic cylinder, a pump cylinder, a pump cylinder chamber, a cylinder and piston pair. This may provide the advantage that the fluid compartment can be directly implemented within the flow channel/line system of the analytical/chromatographic device. For example, a fluid channel of such a system may be equipped with a flow/pressure sensor and a temperature change device in order to provide the analytical device. A valve of such a fluid channel system may then serve as the blocking device.

In one embodiment, the blocking device comprises a valve. In particular, the valve comprises at least one of the following: an inlet valve to an analytical domain, a passive check valve, an active check valve, a rotary fluidic valve, a sample injection valve. This may provide the advantage that closing (in particular the downstream output side of) the fluid compartment can be controlled/regulated in an efficient and reliable manner. In case the blocking device is a valve, no additional cost or effort may be necessary and components anyway comprised in the analytical device could be directly applied. As defined above, the analytical domain of the analytical device may comprise a device for sample separation analysis, in particular a chromatographic device such as a chromatographic column. The inlet valve may be functionalized to not only regulate or control the flow of solvent to the analytical domain, but also to close the fluid compartment, when a thermal property of the solvent is to be determined. In an embodiment, the analytical domain may be part of a sample separation device.

In one embodiment, the flow sensor and/or the pressure sensor is coupled to the inlet/input side of the fluid compartment, in particular upstream of the fluid compartment. The sensor may be arranged at an advantageous location opposite to the blocking device. Thus, the flow could be blocked and a backflow, caused by thermal expansion could be measured efficiently during the solvent or a part of it is within the fluid compartment, or the fluid compartment altogether is heated up or cooled down in a steered, controlled, regulated or monitored way.

In one embodiment, the blocking device is coupled to the outlet/output side of the fluid compartment. In one embodiment, the blocking device is arranged downstream of the fluid compartment. Hence, the sensor is arranged at an advantageous location opposite to the blocking device. Thus, the flow could be blocked and a backflow, caused by thermal expansion, could be measured efficiently.

In one embodiment, the blocking device is configured to completely block the fluid compartment, preventing any inbound or outbound fluid flow to it. In one embodiment, the sensor is a pressure sensor arranged in a fluidic communication to the fluid comprised in the fully blocked fluid compartment. Thus, the pressure change, caused by thermal expansion, could be measured efficiently during the solvent or a part of it within the fluid compartment, or the fluid compartment altogether is heated up or cooled down in a steered, controlled, regulated or monitored way. The pressure change correlated to the temperature change of the solvent in a fully blocked fluid compartment allows to evaluate the CTE according to the formula:

$${( \frac{\partial P}{\partial T} )}_{V} = \frac{α}{{K}_{T}}$$

with K_{T} standing for the solvent compressibility coefficient, which may be input to the pump as a part of a separation method or analytical device program, or may be determined by the pump during or prior to operation in an on-line or off-line manner as known in the art. Once only a part of the solvent comprised in the fully blocked fluid compartment is subject to the temperature change, the formula may be adjusted to:

$${( \frac{\partial P}{\partial T} )}_{V} = \frac{α}{{K}_{T}} \cdot \frac{{V}_{c}}{{V}_{tot}}$$

with V_{c} standing for the volume prone to the temperature change and Vₜₒₜ—for the total enclosed volume. In the case an even better accuracy and precision of the measurement of the thermal property is required, the formula can be further adjusted to take the different solvent compressibility coefficients at different temperatures for the respective partial volumes in the fluid compartment and also to account for the thermal expansion and elasticity of the compartment itself.

In one embodiment the fluid transport control means may comprise a piston arranged in fluidic communication with an at least temporarily fully blocked fluid compartment equipped with a sensor such as a pressure sensor. In one embodiment, the piston may be moved in regulated manner such that the pressure within the fully blocked fluid compartment is held constant during the temperature of the solvent is changed. Thus the piston displacement needed to maintain the pressure constant will represent the volume change of the solvent related to the temperature change.

In one embodiment, the analytical device further comprises: an adjustment device, configured to adjust a device property (device operating/process parameter) based on the determined thermal property (and according to the actual temperature of the separation device or its parts). This may provide the advantage that the obtained thermal property of the solvent can be directly applied to improve the accuracy and/or precision of the solvent flow and, accordingly, the accuracy and/or precision of the entire device, its related analytical methods and analysis results. The device property may be a property of the analytical device, or, in case that the analytical device is part of a sample separation device, the device property may be a property of the sample separation device. In a specific example, the device property may include a pump (piston) movement and/or a solvent intake phase and/or a flow rate.

In one embodiment, the device property comprises at least one of: an adjustment of a pump, an adjustment of a solvent flow (also referred to as an executed flow rate), an adjustment of a displacement rate, a ratio of multiple flow/displacement rates related to different solvents and/or flow paths.

In a specific example, once the thermal expansion coefficient α of a solvent is determined, it can be used for the adjustment of the piston motion in the solvent displacement and intake phases according to a formula:

$${F}_{corr} = {F}_{uncorr} ( 1 + α ( {T}_{act} - {T}_{ref} ) )$$

$$or$$

$${F}_{corr} = {F}_{uncorr} / ( 1 - α ( {T}_{act} - {T}_{ref} ) )$$

or to any equivalent calculation, where: F_{corr} is adjusted displacement or intake velocity (or volume); F_{uncorr} is displacement or intake velocity (or volume) as it were without adjustment for the real solvent temperature during metering; Tact is the actual temperature of the solvent being intaken, metered or delivered; and T_{ref} is the reference temperature, to which the desired or commanded solvent flow is related.

It should be understood that the proposed embodiments may refer to either a solvent intake operation, or to solvent delivery operation or to both, using either solvent properties approximated as pressure independent or solvent properties determined for the specific pressure values or ranges where applicable.

In one embodiment, the solvent is a solvent mixture that comprises two or more solvent portions. This may provide the advantage that also a solvent mixture, which is common for example in liquid chromatograph, can be characterized regarding the thermal property. In one example, the thermal property of each solvent portion is determined using the analytical device separately, for example before mixing the solvent portions. In another example, the thermal property of the solvent mixture is determined using the analytical device after mixing the solvent portions. Such a measurement of the mixed solvent may also verify or confirm the solvent composition, for example if a desired mixing ratio (such as water:acetonitrile, e.g. 47:53 volume/volume) is fulfilled, i.e. if a determined value of a thermal property matches to the expected value for the desired mixing ratio (also commonly referred to as composition).

In one embodiment, the temperature change device comprises one of a heating device, in particular a heating wire or a heating resistor, and a cooling device. This may provide the advantage that a temperature change (heating or cooling) may be provided in a straightforward and easy manner. While in one example, the temperature change device is at least partially arranged in the fluid compartment (for example a heating wire), in another example, the temperature change device is located at least partially external to the fluid compartment (e.g. a heating block or a coil). It may not be necessary to actually measure the temperature change, because in an embodiment it is possible to estimate, calculate, model or guess the temperature change magnitude on the base of the action of the temperature change device, e.g. based on the provided amount of the heat energy. For example, once the heat capacity of the temperature change device is known from calibration or estimation and it is significantly higher than the heat capacity of the contained fluid, the temperature change can be readily approximated by the formula:

$$Δ T = \frac{Q}{C} = \frac{U \cdot I \cdot t}{C}$$

where C is heat capacity of the temperature change device, Q—introduced heat energy, U, I and t are voltage, current and duration of application in the case the temperature change device is based on a resistive electrical heater element.

In a specific example (see also FIG. 4), where an inline measurement is performed, a thermo-anemometric flow sensor is inserted in the solvent line, e.g., the inlet tube of an HPLC pump, (being in this embodiment the fluid compartment), prior to an inlet valve (being here a blocking device). A heating resistor is applied as a heating device (temperature change device) and is built in the line (fluid compartment) between the flow sensor and the inlet valve. Because there are phases in the pump cycle, when the inlet valve is closed, in such phases the end of the fluid compartment, comprising the heating device, is blocked.

Applying a known amount of electrical energy Q to the heating device (comprised in the temperature change device, whereas this embodiment is designed such, that the total heat capacity of the heating device is small compared to that of the surrounding solvent and there is no significant rapid heat transport (no rapid heat loss) to the other parts of the temperature change device) will result in expansion of the solvent around it according to the equation:

$$Δ V = Q ( α / c )$$

where c is volumetric heat capacity of the solvent around the heating device. The volumetric heat capacity of the solvent can be derived from the data collected by the thermo-anemometric flow sensor, may be known a priori or may be an assumed in the typical value range for common solvents as e.g. 2-4.2 J/ml*K. The expansion volume will pass through the flow sensor and the value of ΔV will be determined. Thus, the value of a can be readily determined.

An equivalent result may be obtained by evaluation of the differential of the expansion volume vs. the differential of the applied energy, i.e. evaluation of the expansion flow vs. applied heat power according to the formula

$$F = W ( α / C )$$

with F being the thermal expansion flow and W being the heat power.

In an embodiment, the thermo-anemometric flow sensor may not intrinsically provide an accurate flow signal for an unknown solvent. In this case, a calibration of the flow sensor with an accuracy sufficient for the determination of the thermal expansion coefficient α can be readily achieved by relating the flow sensor signal to a piston motion, e.g. during a dedicated calibration intake executable by the analytical device, e.g. by the pump comprised in the analytical device.

In one embodiment, the temperature change device is at least partially configured as a part of the fluid compartment, in particular as a metal (layer) capillary. This may provide the advantage that the temperature change device does not have to be provided as an additional device, but that it is directly implemented within the fluid compartment, thereby saving costs and efforts. In such an embodiment, a current may be provided to the metal layer of the temperature change device, thereby providing a heating effect. In an illustrative example, at least a part of the sidewalls of the fluid compartment may be covered with a metal layer, thereby providing the temperature change device. In an embodiment the temperature change device can comprise a metal capillary flown through by the solvent and constituting a part of the regular flow path in the system. Because conventionally the parts of the flow path are made mostly of metal and are thus interconnected and grounded, it is advantageous to connect a power supply for heating the capillary with the zero/earth terminal to two points along the capillary, and with the second, voltage output terminal to a third point located between those two points. Doing so the electrical current paths are defined and limited to the sections from the third point to the first point and from the third point to the second point along the capillary, avoiding undesired and undefined currents along other parts of the flow path and/or sample separation device.

In the following, two specific embodiments are described, wherein the temperature change device is arranged as part of the fluid compartment. While the first embodiment requires a temperature sensor, the second embodiment can be applied without a temperature sensor.

In the first specific embodiment (see also FIG. 5), a flow sensor is inserted in the solvent line constituting the fluid compartment, e.g., the inlet tube of an HPLC pump prior to an inlet valve. The temperature change device is implemented as a piece of the solvent conduit (fluid compartment) with known volume, e.g. a piece of a metal capillary. This metal capillary may be implemented to bear a temperature sensor and be homogeneous along its length or bear multiple temperature sensors, which would provide a mean temperature along the metal capillary. By heating the metal capillary from a measured temperature T1 to a new temperature T2 (e.g. by applying an electric current between the ends of the metal capillary), the solvent content of known volume V of the metal capillary will be heated by a known ΔT, and the expansion volume ΔV will escape through the flow sensor, providing all necessary data for determination of the thermal property, in particular the temperature thermal expansion coefficient, according to formula:

$$α = ( Δ V ) / ( V Δ T )$$

In the second specific embodiment, similarly to embodiment described above, the temperature change device may be implemented as a metal capillary, but this time of significant thermal mass, e.g. with a thick walls, such that the thermal capacitance of the tube is much higher than that of the liquid/solvent contained in the capillary. In this case, the heat capacitance of the liquid can be neglected, and the heating may be done by applying a known amount of electrical energy Q to the metal capillary. In this case, the heat-up of the metal capillary related to a given amount of energy Q will always be essentially the same and the temperature sensor may be omitted, in particular once the heat-up of the capillary has been calibrated or calculated once.

In one embodiment, the temperature change device comprises a pump, in particular a piston. In this embodiment, a pressure sensor may be applied. The movement of the pump piston may induce a solvent compression, which in turn invokes a temperature change. Once this temperature change is directly assessed, estimated or evaluated, hereby be seen as the induced temperature change necessary to determine the thermal property.

In a specific embodiment, the thermal property is determined/estimated based on temperature and pressure monitoring of a solvent compression. This can be done based on the equation

$$( α / {K}_{T} ) = {( dP / dT )}_{v}$$

with K_{T} as isothermal compressibility, it is possible to evaluate the thermal expansion coefficient α using the compression process parameters acquirable during pump operation or in a dedicated measurement prior to an analysis. Specifically, K_{T} can be evaluated from the pump operation (piston motion needed to compress a solvent to achieve a given pressure under isothermal or nearly isothermal conditions, e.g. by nearly adiabatic compression and cool-down of a solvent to its initial temperature).

(dP/dT) can also be estimated: ΔP is readily measurable as pressure change during solvent cool-down after compression (using the pressure sensor), whereas ΔT is technically possible, though difficult to be measured directly (which would require miniature temperature sensor within the solvent), but can be estimated indirectly by precise measurement of the temperature of the solvent container (e.g. the pump cylinder wall) and reconstruction of a solvent temperature change using calibration measurements or simulation. Such estimation can also include calculation of the amount of heat freed during compression and back-calculation of the solvent heat-up based on the heat capacity of the solvent as described e.g. in the first embodiment above.

In one embodiment, the analytical device further comprises: a temperature sensor, coupled to the fluid compartment, and configured to measure a temperature with respect to the fluid compartment. This may provide the advantage that, in particular in case that the temperature change device is integrated in the fluid compartment (sidewall), a reliable temperature value can be assessed.

In one embodiment, the thermal property of the solvent is determined pressure-independent or for a specific pressure. Depending on the specific circumstances and the applied measurement method, a pressure-independent or pressure-dependent determination of the thermal property may be favorable. Thereby, the flexibility of the determination is increased.

In one embodiment, the implementation involves determination of a thermal property such as the thermal expansion volume in a hydraulically isolated volume (fluid compartment) by monitoring the pressure during a temperature change or by keeping the pressure constant by volume adjustment e.g. by a regulated piston movement. This may be advantageous due to its simplicity and precision. However, the measurement might be affected by possible parasitic leakages out of the isolated volume (in the fluid compartment).

To mitigate this undesired effect, it may be possible to monitor the course of pressure value or of the volume adjustment value respectively over time. Specifically, during a time, when the temperature in the isolated/blocked solvent volume is not being changed, reference data can be derived. The measurement data, e.g. the course of pressure or of the volume adjustment during the time when the temperature is being changed, can then be set into a mathematical relation to the reference data to yield a leak-independent corrected measurement result. An exemplary embodiment is explained for FIG. 6 below.

In one embodiment, the analytical device/determination device is configured to compensate for (parasitic) leakage of the solvent (volume), when accommodated in the fluid compartment. In particular, the compensation may include an evaluation/determination of the leakage volume. This may be done for example by comparing a pressure value and/or a volume adjustment value during a heating time period (measurement value) with a pressure value and/or a volume adjustment value during a non-heating (reference value).

In an exemplary example, the thermal expansion coefficient can be determined by the following formula, wherein ΔV would be the leakage volume:

$$α = \frac{Δ V}{V Δ T}$$

In an example (see e.g. FIG. 6), more volume is displaced by the leakage than by the heating during the same time, resulting in a negative slope. Yet, there may be other examples, where the slope is positive during the heating. The evaluation may not be affected whether a positive or negative slope is observed.

In an example, the magnitude of ΔV is determined by extrapolation of the volume values before and after the heating period to the time point for example in the middle (center) of the heating phase. The position of determining ΔV may be chosen in a different way, depending on the properties of the regression straight lines (see also FIG. 6). In case that these straight lines are parallel, the position of ΔV may be chosen in a more free manner than in a case were the straight lines are less parallel (parallel to a lower degree). In an example, the degree of parallelism may be determined by a parameter. Based on the parameter, it can be evaluated how much freedom there is with respect to the position of ΔV.

In a specific example (see FIG. 6), the heating may be 7.5° C. within 30 s in an overall time period of 130 seconds. In another example, a heating of 3° C. during 10 seconds in an overall duration of 40 seconds may be applied. Thus, the heating temperature and time may be set in a flexible manner, depending on the present application.

In an example, the larger the heated volume, the larger may be the resulting volume change. The larger volume change is more easily and reliably measurable, whereas the larger the heated volume might be technically disadvantageous with respect to other intended use of the sample separation device (e.g. to chromatographic separation). Thus there might exist a compromise or optimum volume of the heating device. A minimum required volume may be given by i) the resolution of the piston position measurement (encoder) and/or ii) the noise of the pressure measuring device multiplied with the total elasticity of the isolated/blocked volume (compressibility of the solvent in the heated and the not heated volume plus the elasticity of the container).

In an example, ΔV may be the larger, the larger temperature change is (see above). Yet, water and water-rich mixtures may have a thermal expansion coefficient that highly depends on the temperature, so that a high magnitude of the temperature change may not be desirable. Further, the measurement device should be cooled down after the heating, which may be easier if the heating had been less.

In an example, the faster the heating, the smaller may be the relative effect of external influences, for example temperature change of a not-heatable container or a sporadic leakage. The heating duration may be limited by the available heating power and the thermic equilibration time of the heatable volume.

In an example, the larger the observation time before and after the heating (and thus the time intervals used for fitting tangents), the more accurate can the tangents be fitted/defined.

In one embodiment, the sample separation device further comprises: a sample injection point, where a sample is injected into the solvent, wherein the fluid compartment (the analytical device) is arranged upstream or downstream of the mixing point.

In one embodiment, the sample separation device further comprises: a solvent mixing point, where at least two solvent portions or solvent flows may be mixed, wherein the fluid compartment (the analytical device) is arranged upstream or downstream of the solvent mixing point.

In one embodiment the sample separating device (such as a chromatographic column) may be used as a fluidic restrictor, which in combination with a pressure sensor, such as a system pressure sensor, may deliver data about forced solvent transportation in the flow path. Specifically, any part of the flow path located between a solvent valve, such as e.g. a pump inlet check valve, and the sample separating device may be used as fluid compartment. The solvent flow generated during heating the solvent in the fluid compartment will generate a pressure drop at the sample separating device, which can be used to evaluate the volumetric flow or can be integrated over the heating time to yield the value of thermal expansion volume.

In one embodiment, the sample separation device further comprises: a solvent drive, configured to drive the solvent as a mobile phase, wherein the fluid compartment (the analytical device) is arranged upstream or downstream of the solvent drive.

It becomes aware from the embodiments described directly above, that there is a high design flexibility regarding where the fluid compartment can be located in the analytical device/sample separation device. Depending on the present circumstances and the applied measurement method, different locations may be specifically favorable.

With respect to a chromatographic device, the fluid compartment may be advantageously implemented or located in the inlet path to the chromatographic pump, in the lines connecting the pump and the autosampler. Still another advantageous embodiment comprises a fully blockable fluid compartment being a part or the autosampler, preferably comprising the sample loop, the metering device or both. In this case use can be made of at least one of: a pressure sensor, piston of the metering device and the injection valve already comprised in the autosampler.

In one embodiment, determining the thermal property is done in-line (online, real time). This may provide the advantage that the thermal property of the solvent can be determined “on-the-fly”, i.e. directly during operation of the analytical device/sample separation device). Preferably, the fluid compartment may be directly implemented as part of the fluid channel system of the device.

In one embodiment, determining the thermal property is done off-line (pre-analysis). In this embodiment, the fluid compartment may be designed as a regular part of the system or as an additional entity, so that a thermal property of the solvent may be determined in a separate measurement not simultaneous with a regular operation of the sample separation device, specifically of the chromatography device. Thereby, the accuracy may be increased, since more time may be reserved for the measurement.

In one embodiment, determining/estimating the thermal property comprises an artificial intelligence (AI) algorithm, in particular a neural network. The terms “AI”, “machine learning”, and “deep learning” (in the present document, machine learning and deep learning are considered as kinds of AI), may refer to approaches to mimic cognitive functions of a human mind, in particular learning and problem solving. There have been developed a plurality of different mathematical algorithms and computational models to implement AI functionalities. These include, for example, neural networks, genetic algorithms, support vector machines, and kernel regression. The main purpose of these approaches may be seen in improving a present algorithm by training it using training data, so that a learning effect occurs and the problem-solving ability of the algorithm improves over time. Accordingly, an AI algorithm may be applied to constantly improve the estimation of the thermal property. Evolution of the AI algorithm may be accompanied by human interaction or may be completely automatic.

In an embodiment, there is described using a measurement of a thermal property to adjust an operation parameter of a sample separation device. In particular, where the thermal property is one of: specific volume, density, thermal expansion coefficient, CTE, of a solvent. More in particular, where the operation parameter of a sample separation device is one of: flow rate; stroke volume; stroke length; stroke frequency; piston displacement speed; ratio of flow rates; ratio of stroke volumes; ratio of stroke lengths; ration of stroke frequencies; ratio of piston displacement speeds.

In one embodiment, the chromatography device is a fluidic chromatography device, in particular a high-performance liquid chromatography, HPLC, device.

In one embodiment, the chromatography device comprises a mobile phase (solvent) drive and a separating device, wherein the mobile phase drive is configured for driving a mobile phase through the separating device, and the separating device is configured for chromatographically separating compounds of a sample fluid in the mobile phase.

In one embodiment, the analytical device and/or the sample separation device comprises a liquid chromatography system, wherein the sample fluid is a sample liquid, the mobile phase is comprised of one or more liquid solvents, and the separating device is a chromatographic column configured for separating compounds of the sample dissolved in the mobile phase.

Embodiments of the present disclosure might be embodied based on most conventionally available HPLC systems, such as the Agilent 1220, 1260 and 1290 Infinity LC Series (provided by the applicant Agilent Technologies).

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1, the entire contents of which are incorporated by reference herein, or the Agilent 1200 Series HPLC-Chip/MS System provided by the applicant Agilent Technologies). The individual components are retained by the stationary phase differently and separate from each other while they are propagating at different speeds through the column with the eluent. At the end of the column, they elute at least partly separated from each other. During the entire chromatography process, the eluent might be also collected in a series of fractions. The stationary phase or adsorbent in column chromatography usually is a solid material. The most common stationary phase for column chromatography is based on silica gel, followed by alumina.

The mobile phase (or eluent) can be either a pure solvent or a mixture of different solvents. It can also contain additives, i.e. be a solution of the additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation, water and organic solvent are delivered in separate containers, from which the gradient pump delivers a programmed blend to the system. Other commonly used solvents may be isopropanol, tetrahydrofuran (THF), hexane, ethanol and/or any combination thereof or any combination of these with aforementioned solvents.

The sample fluid might comprise any type of process liquid, natural sample like juice, body fluids like plasma or it may be the result of a reaction like from a fermentation broth, bio reactor, digestion, or other type of sample preparation.

The fluid is preferably a liquid but may also be or comprise a gas and/or a supercritical fluid (as e.g. used in supercritical fluid chromatography—SFC—as disclosed e.g. in U.S. Pat. No. 4,982,597 A, the entire contents of which are incorporated by reference herein).

The pressure in the mobile phase might range from 2-200 MPa (20 to 2000 bar), in particular 10-150 MPa (100 to 1500 bar), and more particularly 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

In an embodiment, the temperature change device comprises a heating device, in particular at least one of: a resistive heating device, a heating wire, a section of a metal capillary, a heating resistor, a semiconductor heating device, a diode, a bipolar junction transistor, a field effect transistor (FET), a Peltier element, an NTC (negative temperature coefficient) or PTC (positive temperature coefficient) resistive heating element, a ceramic heating element, or a heat transfer cooling element. In an embodiment, the temperature change device comprises a cooling device, in particular a Peltier element and/or a heat transfer cooling element.

According to an example to better understand one aspect of the disclosure, a rough estimation of the CTE, e.g. based on solvent compressibility can be made and imposed as an input value for the adjustment device. As the solvent compressibility is measurable by the pump during operation, one can use a rough correlation between the solvent compressibility and the thermal expansion coefficient. This correlation is to some extent present for the most important HPLC solvents (e.g. water has compressibility of ˜4e-5/bar and a thermal expansion coefficient of ˜3e-4/° C., whereas organic solvents such as methanol and acetonitrile have compressibility of ˜(8-10)e-5/bar and a thermal expansion coefficient of ˜12e-4/° C. The thermal expansion coefficient can depend on the solvent mixture composition. However, a correlation between the thermal expansion coefficient and compressibility shows strong deviations from linearity for solvent mixtures, e.g. for ACN-Water. Thus, the applicability of such “empiric” approach is strongly limited for solvent mixtures, albeit being suitable for many pure or nearly pure solvents and providing some improvement in comparison with no adjustment at all even for solvent mixtures.

Embodiments of the present disclosure may be partly or entirely embodied or supported by one or more suitable software programs or products (or software), which may be stored on or otherwise provided by any kind of non-transitory medium or data carrier, and which may be executed in or by any suitable data processing unit such as an electronic processor-based computing device (or system controller, control unit, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform or control one or more of the steps of the method of any of the embodiments disclosed herein.

### BRIEF DESCRIPTION OF THE DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 illustrates a sample separation device with an analytical device according to an exemplary embodiment.

FIG. 2 illustrates an exemplary embodiment of an analytical device.

FIG. 3 illustrates a further exemplary embodiment of an analytical device.

FIG. 4 illustrates an exemplary embodiment of measuring the flow rate of two different solvents over a heating cycle.

FIG. 5 illustrates an exemplary embodiment of measuring the flow rate of a single solvent over a heating cycle.

FIG. 6 illustrates an exemplary embodiment of measurement data processing including compensating for a leakage of the solvent over a heating cycle.

FIG. 7 illustrates another embodiment of the analytical device, wherein the fluid compartment with attached temperature change device constitutes a part of fluid conduit permanently connected to a primary cylinder of a fluidic drive, according to an exemplary embodiment of the present disclosure.

### DETAILED DESCRIPTION

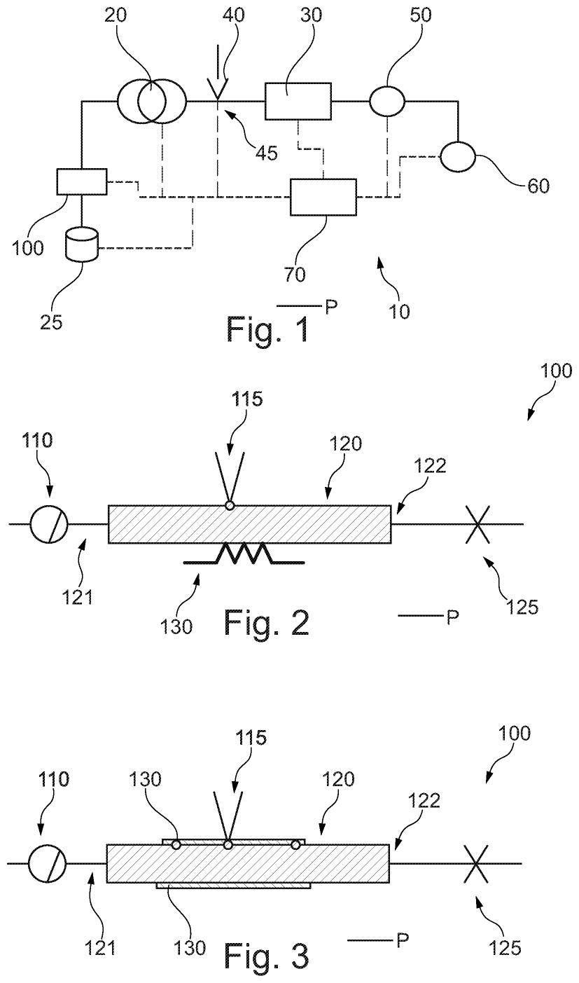

Referring now in greater detail to the drawings, FIG. 1 depicts a general schematic of a sample separation device 10 that comprises an analytical device 100 (see detailed description for FIGS. 2 and 3 below). A solvent (mobile phase) drive 20 (such as a pump) receives a solvent as the mobile phase from a solvent supply 25. The solvent drive 20 drives the mobile phase through a separating device 30 (such as a chromatographic column), which can be seen here the analytical domain of the device. A sample injector 40 (also referred to as sample introduction apparatus, sample dispatcher, etc.) is provided between the solvent drive 20 and the separating device 30 in order to subject or add (often referred to as sample introduction) portions of one or more sample fluids into the flow of a mobile phase at a mixing point 45. The separating device 30 is adapted for separating compounds of the sample fluid, e.g. a liquid. A detector 50 is provided for detecting separated compounds of the sample fluid. A fractionating unit 60 can be provided for outputting separated compounds of sample fluid. In one embodiment, at least parts of the sample injector 40 and the fractionating unit 60 can be combined, e.g. in the sense that some common hardware is used as applied by both of the sample injector 40 and the fractionating unit 60.

The separating device 30 may comprise a stationary phase configured for separating compounds of the sample fluid. Alternatively, the separating device 30 may be based on a different separation principle (e.g. field flow fractionation).

While the mobile phase can comprise one solvent only, it may also be mixed of a plurality of solvents. Such mixing might be a low-pressure mixing and provided upstream of the solvent drive 20, so that the solvent drive 20 already receives and pumps the mixed solvents as the mobile phase. Alternatively, the solvent drive 20 might comprise plural individual pumping units, with plural of the pumping units each receiving and pumping a different solvent or mixture, so that the mixing of the mobile phase (as received by the separating device 30) occurs at high pressure and downstream of the mobile phase drive 20 (or as part thereof). The composition (mixture) of the mobile phase may be kept constant over time, the so-called isocratic mode, or varied over time, the so-called gradient mode.

A data processing device 70, which can be a conventional PC or workstation, might be coupled (as indicated by the dotted arrows) to one or more of the devices in the sample separation device 10 in order to receive information and/or control operation.

In this specific example, the analytical device 100 (which is described in more detail below) is arranged between the solvent supply 25 and the solvent drive 20. Nevertheless, the analytical device 100 can also be arranged at other locations, for example between the solvent pump 20 and the mixing point 45, or even in process direction P downstream of the mixing point 45. In this example, the data processing device 70 can comprise the determination device and/or the adjustment device of the analytical device 100.

FIG. 2 illustrates an exemplary embodiment of the analytical device 100 as already mentioned above. The analytical device 100 comprises a fluid compartment 120, here realized as a fluid channel, that is arranged in the flow path of the solvent, for example between solvent supply 25 and solvent drive/pump 20. The fluid compartment 120 comprises a defined input side 121 for the solvent (being in process direction P upstream) and a defined output side 122 for the solvent (being in process direction P downstream). The analytical device 100 further comprises a blocking device 125 that is configured to close at least partially the fluid compartment 120, so that the solvent flow is blocked, and a solvent-related measurement can be performed. In the example shown, the blocking device 125 is implemented as a valve that blocks the output side 122 (here a capillary process downstream of the channel). Specifically, the valve 125 is an input valve that controls the flow of solvent (mobile phase) to the actual analytical domain of the sample separation device 10, in particular the separating device 30. In particular, such input valve can be configured to allow the flow in one direction, e.g. from the solvent supply 25 to the solvent drive/pump 20 and to block the flow in the opposite direction. Such input valve as a check valve may be considered as blocked once the pressure at the side of the solvent drive/pump 20 is higher than at the side of the solvent supply 25, which state is easily achievable by operating the solvent drive/pump 20.

The analytical device 100 further comprises a flow sensor 110 (additionally or alternatively a pressure sensor), coupled to the fluid compartment 120 (at the input side 121), and arranged in process direction P upstream to the fluid compartment 120. Further shown is a temperature sensor 115, here a thermocouple, coupled to the fluid compartment 120, and configured to measure a temperature with respect to the fluid compartment 120/the solvent therein. While the temperature sensor 115 can be crucial for a specific embodiment, it can be only optional for another embodiment.

The analytical device 100 further comprises a temperature change device 130, coupled to the fluid compartment 120, and configured to change a temperature in the fluid compartment 120/the solvent therein. In the example of FIG. 2, the temperature change device 130 is realized as a heating device arranged external to the fluid compartment 120. In another embodiment (not shown), the thermal change device 130 may be located (partially) in the fluid compartment 120, e.g. configured as a heating wire.

The temperature change device 130 may be configured as an electrical heating device, such as resistive heater, semiconductive heater, in particular a transistor, an FET, a diode, a thyristor, a triac, a PTC, an NTC, a Peltier element, or as a heat transfer heating element, in particular as a heat exchanger, a heat-exchanger comprising a heat pipe or a microfluidic heat exchanger, in particular as a liquid-liquid heat exchanger, where the heat carrier liquid is provided by external means steered or controlled by the control device of the analytical device 100.

The temperature change device 130 may be configured as cooling device, in particular as a Peltier element or as a heat transfer element, in particular as a gas-liquid or liquid-liquid heat exchanger, where the heat carrier is configured to have a lower temperature, than the fluid compartment 120.

Furthermore, the analytical device 100 comprises a determination device that is configured to determine a thermal property of the solvent based on the flow measurement of the flow sensor 110 (alternatively the pressure measurement of the pressure sensor) and the temperature change (e.g. ΔT). The determination device is not shown in the Figures and can be implemented in a variety of manners, e.g. as part of a control device of the analytical device 100 and/or as part of the data processing device 70 of the sample separation device 10.

FIG. 3 illustrates a further exemplary embodiment of the analytical device 100. This embodiment is very similar to the one described for FIG. 2 above with the difference being that the temperature change device 130 is not implemented as an additional device. Instead, the temperature change device 130 is realized as part of the fluid compartment 120. In particular, the temperature change device 130 is configured as a metallic channel/capillary around the solvent accommodated in the fluid compartment 120. An electric current can be provided to the metal of the temperature change device 130, thereby inducing a heating. Depending on the design of the temperature change device 130 in this example, a temperature sensor 115 can be mandatory or optional. For example, in case that the metal layer is rather thin, one or more temperature sensors 115 may be necessary. However, in case that the metal layer is rather thick, influence of the solvent can be neglected and the temperature sensor 115 would become optional.

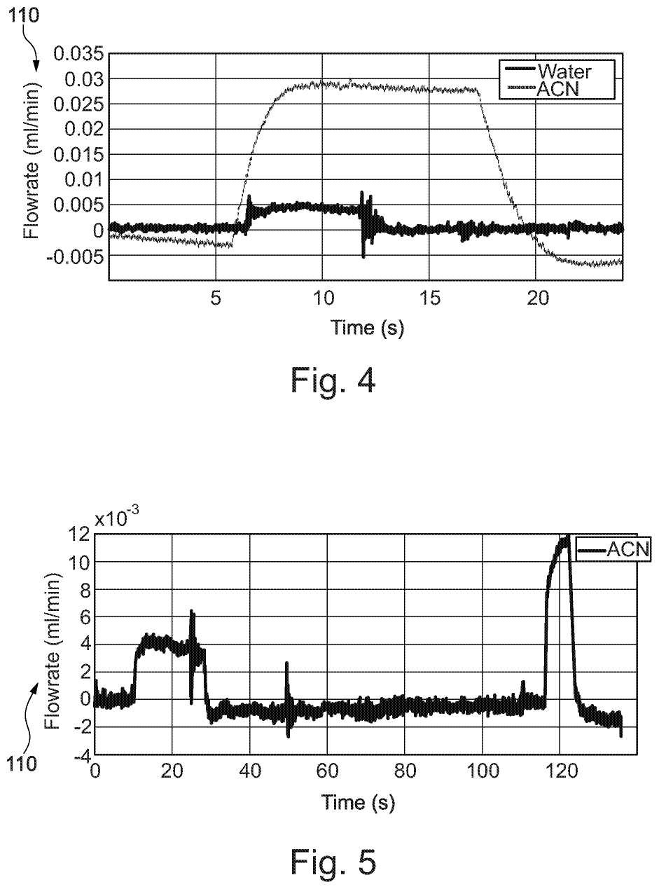

FIG. 4 illustrates an exemplary embodiment of measuring the flow rate of two solvents in an analytical device 100 according to the embodiment of FIG. 2. It is shown the flow sensor 110 signal (uncorrected for solvent type) for thermal expansion of water and acetonitrile (ACN). An aliquot of either solvent was enclosed in a closed fluid compartment 120 and heated with a resistive heater (as temperature change device 130). A pulse of power of 1 Watt magnitude was applied to the resistive heater 130. The thermal expansion was then measured with the flow sensor 110, connected fluidically to the fluid compartment 120. The expansion flow for both solvents is clearly assessable as the flow sensor signal and corresponds to the expected values for heat capacities and CTE values of water and ACN, applied heat power (1 W), and sensitivities of the flow sensor 110 to water and ACN flow.

FIG. 5 illustrates an exemplary embodiment of measuring the flow rate of a solvent in an analytical device 100 according to the embodiment of FIG. 3. A metal (stainless steel) capillary, being part of the fluid compartment 120, is used as the temperature change device 130. About 150 μl volume of ACN were filled in the fluid compartment 120, which was blocked on one end (by the blocking device 125) and connected to a flow sensor 110. Electric current pulses were applied to the metal capillary 130, thereby inducing the heat expansion flow. The applied power was different, though the achieved metal capillary heat-up monitored with a thermocouple (temperature sensor 115) was similar in both cases, being in the range of several ° C. Thus, the flow expansion signals appear as peaks of similar area (representing expansion volume) but different height (representing expansion flow rate).

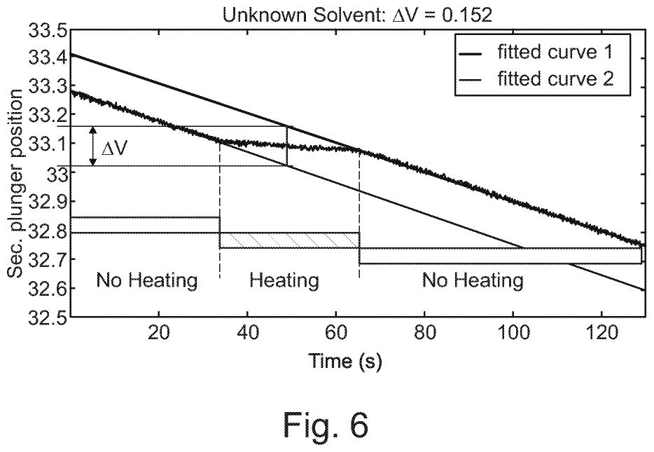

FIG. 6 illustrates an exemplary embodiment of compensating for a leakage of the solvent volume. In this example, an unknown solvent was blocked in a pump cylinder connected to a planar structure, being the fluid compartment 120, accommodating 50 μl of solvent volume. The temperature-change device 130 (e.g. a heater) was coupled to the fluid compartment 120 and the temperature was controlled by a temperature sensor 115 coupled to the fluid compartment 120. Alternatively, the temperature could be estimated based on the added energy and heat capacity of the fluid compartment 120 with coupled parts like heat spread pads. The pressure value in the (isolated/blocked) solvent volume in the fluid compartment 120, containing the unknown solvent, was regulated to a constant value via the pump piston motion.

In FIG. 6, the piston position (y-axis, in μl) over time (x-axis in seconds) is shown. The fluid compartment 120 accommodates a 50 μl portion of the solvent volume, which is heated during a period between 35 seconds and 65 seconds. The temperature of the heated portion is increased by 7.5° C. during the heating period. The reference data in this case is the slope of the piston position over time during not heating (or an expected piston position change (under unchanged temperature) over the duration of the heating interval). The measurement data in this example is the slope of the piston position over time during heating (or, alternatively, the measured piston position change during the heating time interval).

Subtraction of the reference data from the measurement data yields the measurement result, for example as the volume change speed (which needs to be related to the temperature change speed) or as the volume change, i.e. the expansion volume, which needs to be related to the magnitude of the temperature change. In the example of FIG. 6, the evaluation is illustrated graphically by determination of the expansion volume ΔV as the difference of the piston positions before and after the heating procedure, extrapolated to the midpoint of the heating interval. The exemplary measurement yields expansion volume of 0.152 μl for the heated solvent volume of 50 μl over a temperature increase of 7.5° C.

Thus, the thermal expansion coefficient under given conditions appears to be in this example:

$$α = \frac{Δ V}{V Δ T} = \frac{0.152}{50 * 7.5 ° C .} = 4.1 * 1 {0}^{- 4} * {C}^{- 1}$$

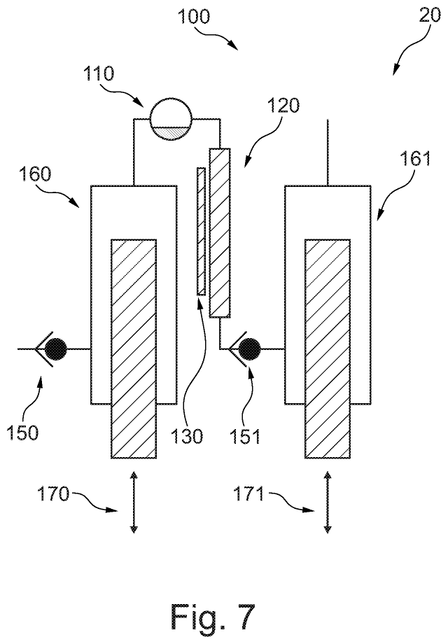

FIG. 7 illustrates still another embodiment of the analytical device 100. In this embodiment the fluid compartment 120 with attached temperature change device 130 constitute a part of fluid conduit permanently connected to a primary cylinder 160 of a fluidic drive 20 (of a binary pump). Also a sensor, e.g. a pressure sensor 110, is fluidically connected to the primary cylinder 160 and the fluid compartment 120. The fluidic inlet side of the analytical device 100 is fluidically blockable by the inlet check valve 150, whereas the fluidic outlet side of the analytical device 100 is fluidically blockable by the outlet check valve 151. The volume enclosed in the analytical device 100 can be adjusted by means of the primary piston 170. The operation sequence of this embodiment may be as follows: the secondary piston 171 can be driven into the secondary cylinder 161, thus generating a fluid flow into the system, which results in a pressure elevation in the secondary cylinder 161 and closure of the outlet check valve 151. The primary piston 170 can then be slightly driven into the primary cylinder 160, which results in a pressure elevation in the primary cylinder 160 (in regulated manner, such that the pressure in the primary cylinder 160 measured by the sensor 110 does not exceed the pressure in the secondary cylinder 161 and thus does not open the outlet check valve 151). This leads to the closure of the inlet check valve 150, thus completely blocking the fluid in the analytical device 100. Then, a temperature change of the fluid compartment 120 may be induced by an action of the temperature change device 130, whereas the primary piston 170 may be moved in regulated manner to maintain the pressure in the analytical device 100 (fluid compartment 120; primary cylinder 160) constant. Displacement of the primary piston 170 can be necessary to compensate for the effect of the temperature change corresponds to the volume change of the fluid in the fluid compartment 120, which provides data basis for evaluation of a thermal property of the fluid.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control unit 70 and/or analytical device 100 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein that, when executed by a processing module of an electronic system (e.g., the control unit 70 and/or analytical device 100 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

### REFERENCE SIGNS

10 Sample separation device, chromatographic device
20 Solvent drive
25 Solvent supply
30 Separating device
40 Sample injector
45 Mixing point
50 Detector
60 Fractionating unit
70 Data processing device
100 Analytical device
110 Flow sensor
115 Temperature sensor
120 Fluid compartment
121 Input side
122 Output side
125 Blocking device, valve
130 Temperature change device
150 Inlet check-valve
151 Outlet check-valve
160 Primary cylinder
161 Secondary cylinder
170 Primary piston
171 Secondary piston
P Process direction

1. An analytical device, comprising:
a fluid compartment, configured to accommodate a solvent;
a blocking device, configured to close the fluid compartment at an input side and/or an output side;
a flow sensor and/or a pressure sensor, coupled to the fluid compartment, and configured to perform a measurement with respect to the solvent;
a temperature change device, coupled to the fluid compartment, and configured to perform a temperature change with respect to the solvent; and
a determination device configured to determine a thermal property of the solvent based on the measurement and the temperature change.

2. The analytical device according to claim 1, wherein the thermal property of the solvent comprises at least one of density; volume; viscosity; compressibility.

3. The analytical device according to claim 1, wherein the thermal property comprises the thermal expansion coefficient, CTE, of the solvent.

4. The analytical device according to claim 1, wherein the fluid compartment comprises at least one of a fluid channel; a fluid conduit; a fluid capillary; a hydraulic cylinder; a pump cylinder; a pump cylinder chamber; a cylinder and piston pair.

5. The analytical device according to claim 1, wherein the blocking device is selected from the group consisting of: a valve; an inlet valve to an analytical domain; a passive check valve; an active check valve; a rotary fluidic valve; and a sample injection valve.

6. The analytical device according to claim 1,
wherein the flow sensor and/or the pressure sensor is coupled to the input side of the fluid compartment; and/or
wherein the flow sensor and/or the pressure sensor is arranged upstream of the fluid compartment.

7. The analytical device according to claim 1,
wherein the blocking device is coupled to the output side of the fluid compartment; and/or
wherein the blocking device is arranged downstream of the fluid compartment.

8. The analytical device according to claim 1, further comprising at least one of:
an adjustment device configured to adjust a device property based on the determined thermal property;
an adjustment device configured to adjust a device property based on the determined thermal property, wherein the device property is selected from the group consisting of: a device operation parameter; an adjustment of a pump; an adjustment of a solvent displacement rate; and a ratio of multiple flow/displacement rates related to different solvents and/or flow paths.

9. The analytical device according to claim 1, wherein the solvent is a solvent mixture that comprises two or more solvent portions.

10. The analytical device according to claim 1, wherein the temperature change device is selected from the group consisting of: a heating device; a resistive heating device; a heating wire; a section of a metal capillary; a heating resistor; a semiconductor heating device; a diode; a bipolar junction transistor; a field effect transistor; FET, a Peltier element: an NTC resistive heating element; a PTC resistive heating element; a ceramic heating element; a cooling device; and a heat transfer cooling element.

11. The analytical device according to claim 1, comprising at least one of the following:
wherein the temperature change device is at least partially configured as a part of the fluid compartment;
wherein the temperature change device is at least partially configured as a metal capillary.

12. The analytical device according to claim 1, comprising at least one of the following:
wherein the temperature change device comprises a pump;
wherein the temperature change device comprises a piston.

13. The analytical device according to claim 1, further comprising a temperature sensor, coupled to the fluid compartment, and configured to measure a temperature with respect to the fluid compartment.

14. The analytical device according to claim 1, wherein the thermal property of the solvent is determined pressure-independent or for a specific pressure.

15. The analytical device according to claim 1, configured to compensate for a leakage of the solvent, accommodated in the fluid compartment.

16. A sample separation device, comprising:
the analytical device according to claim 1; and
a separating device configured to separate a sample.

17. The sample separation device according to claim 16, further comprising:
a mixing point where the sample is injected into the solvent, and wherein the fluid compartment is arranged upstream or downstream of the mixing point; and/or
a solvent mixing point, where two or more solvent portions are mixed to form the solvent, and wherein the fluid compartment is arranged upstream or downstream of the solvent mixing point; and/or
a solvent drive configured to drive the solvent as a mobile phase, and wherein the fluid compartment is arranged upstream or downstream of the solvent drive.

18. A method for determining a thermal property of a solvent, the method comprising:
streaming the solvent in a fluid compartment;
blocking the fluid compartment at an input side and/or an output side;
performing a temperature change with respect to the solvent;
performing a flow-related measurement and/or a pressure-related measurement with respect to the solvent; and
determining the thermal property of the solvent based on the flow-related measurement and/or the pressure-related measurement and the temperature change.

19. The method according to claim 18,
wherein determining the thermal property is done in-line; or
wherein determining the thermal property is done off-line.

20. (canceled)
